(19) United States
(12) Patent Application Publication
(10) Pub. No.: US 2018/0153298 A1
(43) Pub. Date: Jun. 7, 2018

(54) INDICATING TOOTHBRUSH

(71) Applicant: Evan Talbert, LOS ANGELES, CA (US)

(72) Inventor: Evan Talbert, LOS ANGELES, CA (US)

(21) Appl. No.: 15/369,700

(22) Filed: Dec. 5, 2016

(51) Int. Cl. A46B 15/00; A46B 9/04; A61C 17/22

(52) U.S. Cl. CPC A46B 15/001; A46B 9/04; A46B 15/0044; A61C 17/221; A46B 15/004; A46B 15/0008; A46B 15/0046

(57) ABSTRACT

The disclosure provides for a toothbrush comprising a head, a neck, and a handle. The neck connects the head to the handle. The neck may meet the handle at an angle. The handle comprises an indicator assembly, comprising one or more contact plates, a light source, a circuit board, and a power source. The circuit board may connect the contact plates, the light source, and the power source to each other. A gap may separate the contact plates, or portions thereof. Movement of the neck about the angle may reduce the gap, causing the contact plates, or portions of, to come into contact and activate the indicator assembly. This may cause the light source to emit a light. The handle may comprise a counter that tracks the number of activations. The light source may emit a color dependent on the number tracked by the counter.

### BACKGROUND

An overused toothbrush can reduce the effectiveness of the toothbrush, can damage one's gums and teeth, and has the potential to spread unwanted bacteria. As such, it is well-known that a toothbrush must be disposed of and replaced. However, the tracking of when one will need to replace his or her toothbrush is often difficult.

Conventional toothbrushes with indicators to alert an operator that it is time for a replacement generally includes bristles that change color when the bristles wear away. However, these indicator bristles can be ineffective and unreliable, as the bristles may change color based on factors independent of usage. Other toothbrushes with indicators may include a motion sensor that triggers the activation of a circuit. Typically, the circuit has a preset number of times it can be activated and once the preset value is met, the toothbrush indicates to the user that it needs to be replaced. However, this mechanism is also unreliable, as the toothbrush may be moved even when it is not in use. Thus, this mechanism may lead to premature replacement of the toothbrush.

### SUMMARY

Exemplary embodiments described herein include a toothbrush. The toothbrush may include a head portion, a neck portion, and a handle portion. The neck portion may connect the head portion to the handle portion. The head portion may include one or more bristles. The handle portion may include an indicator assembly and may be ergonomic.

The indicator assembly may include an alert to indicate when the toothbrush is ready to be replaced. The alert may be audial or visual. In an exemplary embodiment, the alert is activated when the lifespan of the toothbrush is reached as determined by a tracked use time. The alert may also or alternatively indicate a desired use time for the toothbrush. For example, at each use, the toothbrush may provide an alert when the toothbrush has been in use for a requisite amount of time. The alert may include a light, sound, vibration, or combinations thereof. The alert may be the same alert as that used to track lifespan or may be a separate alert.

The indicator assembly may include two contacting surfaces that are separated in a non-use position and in contact in a use position or sometime during use. When in contact, the contacting surfaces may close a circuit that is used to track use time. In an exemplary embodiment, the contacting surfaces are configured to contact when a neck portion of the toothbrush is flexed.

### DRAWINGS

FIG. 1 illustrates a cross sectional view of an exemplary embodiment described herein.

FIG. 2 illustrates a component view according to embodiments described herein.

FIG. 3 illustrates a side view of an exemplary embodiment described herein.

FIG. 4 illustrates a cross sectional view of an exemplary embodiment as described herein.

FIG. 5 illustrates a component view according to embodiments described herein.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein.

As used herein, the term “acute” indicates any angle that is less than 90°. As used herein, the term “obtuse” indicates any angle that is greater than 90°.

As used herein, the terms “and” and “or” are interchangeable such that any recitation that provides a combination of elements may be used separately and any identified element may be used alone or may be used in combination such as including all elements or any sub-combination of elements.

Exemplary embodiments described herein include a toothbrush. The toothbrush may include a head portion, a neck portion, and a handle portion. The neck portion may connect the head portion to the handle portion. The head portion may include one or more bristles. The handle portion may include an indicator assembly and may be ergonomic.

Although embodiments of the invention may be described and illustrated herein in terms of a toothbrush with an indicator, it should be understood that embodiments of this invention are not so limited, but are additionally applicable to other devices requiring life tracking having a neck portion. Exemplary features disclosed herein may be used in any combination, such that features may be removed, duplicated, integrated, separated, etc.

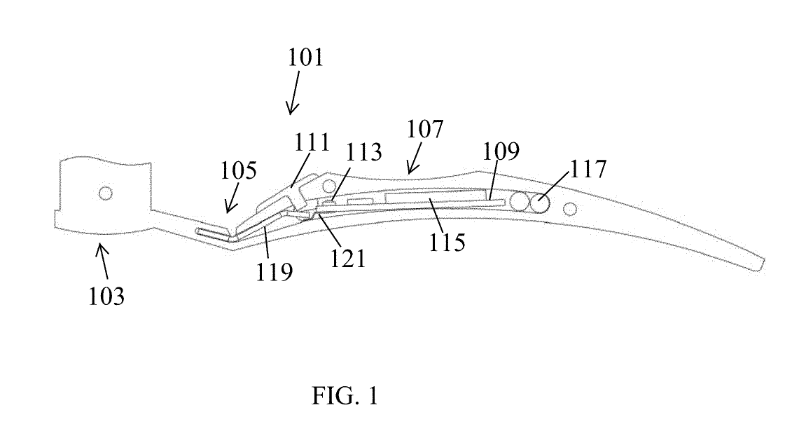

FIG. 1 illustrates a perspective view of an exemplary embodiment of a toothbrush. As shown in FIG. 1, the toothbrush 101 may comprise a head portion 103, a neck portion 105, and a handle portion 107. The neck portion 105 may connect the head portion 103 to the handle portion 107. The handle portion 107 may include an indicator assembly. The indicator assembly may be used to track the use of the toothbrush or provide an alert to the user of when to change the toothbrush.

The indicator assembly may include two contacting surfaces that are separated in a non-use position and in contact in a use position. When in contact, the contacting surfaces may close a circuit that is used to track use time. The tracked use time may be a set value associated with each use that is incremented when the contacting surface directly touch initially or touch for a threshold amount of time. The tracked use time may not be again incremented for a period of time regardless of the contact between the contacting surfaces for another threshold period of time, such as a time equivalent or approximate to the set value. The tracked use time may be an incremented or decremented counter tracking the number of uses of the toothbrush without an associated set value. The tracked use time may be a tracked time of actual direct touching between the contacting surfaces. In an exemplary embodiment, the contacting surfaces are configured to contact when a neck portion of the toothbrush is flexed.

The indicator assembly may include an alert to indicate when the toothbrush is ready to be replaced. The alert may be audial or visual. In an exemplary embodiment, the alert is activated when the lifespan of the toothbrush is reached as determined by the tracked use time. In an exemplary embodiment, the alert includes a light that is a first color for use when the toothbrush can be in use and another color when the toothbrush should be replaced. The first color may include one or more colors to indicate a progression toward replacement. For example, a first color, such as green, may be used when the toothbrush is initially used until a midpoint in the toothbrush lifespan. The midpoint may be anywhere from the beginning to the end of use, and does not require an exact middle of lifespan. For example, the midpoint may be at ½, or may be at ⅔ or ¾ of the life span of the toothbrush. A second color, such as yellow or orange, may be used in the later part of the toothbrush lifespan. A third color, such a red, may be used when the toothbrush is at its useful lifespan and should be replaced. Other indicator combinations may be used, such as changing colors, intensity, on/off or flashing patterns, vibrations, or audial indicators as well.

The alert may also or alternatively indicate a desired use time for the toothbrush. For example, at each use, the toothbrush may provide an alert when the toothbrush has been in use for a requisite amount of time. The alert may include a light, sound, vibration, or combinations thereof. The alert may be the same alert as that used to track lifespan or may be a separate alert. In an exemplary embodiment, a light is illuminated when the brush is first in use and turns off after the requisite amount of time. The light may be the same as used to track lifespan, such that the illumination changes intensity, pattern, color, or combinations thereof to indicate when to change the toothbrush. The alert may also include a light, sound, or vibration starting or occurring at the end of the requisite amount of time.

In an exemplary embodiment, the indicator assembly includes a base plate 109, a circuit, and a lens 111. The circuit is defined by one or more contact plates, a light source 113, a circuit board 115, and a power source 117. The base plate 109 may connect the circuit together, thus the base plate 109 may connect the one or more contact plates, the light source 113, the circuit board 115, and the power source 117 together. The power source 117 may supply power to the light source 113, thereby causing the light source 113 to emit a light. In an exemplary embodiment, the handle 107 may have an interior cavity. The base plate 109 and the circuit may be located within the interior cavity. The handle 107 may be molded around the base plate and circuit.

In an exemplary embodiment, the one or more plates may be a first plate 119 and a second plate 121. As illustrated in FIG. 1, the first plate 119 may be in an upper portion of the handle 107 and the second plate 121 may be proximate the first plate. The second plate 121 may be positioned offset from the first plate such that the first plate is closer to the head portion than the second plate. The first plate and second plate may include an overlapping area in which both the first plate and second plate portions are the same distance from the heat portion. The second plate 121 may also be located close to the first plate 119 but out of contact when an outside force is not applied to the toothbrush (i.e. in a rest configuration). The circuit may include the light source 113, the first 119 and second 121 plates, and the power source 117. The circuit may be completed when the first 119 and second 121 plates come into direct contact. The completion of the circuit may cause power from the power source 117 to travel to the light source 113, thereby causing the light source 113 to illuminate. A lens 111 may be used to diffuse, focus, or direct the light, or protect the light source for ease of cleaning.

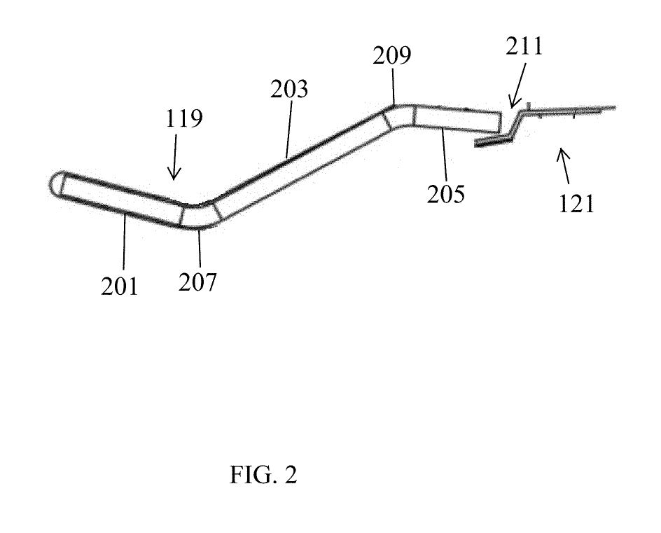

In an exemplary embodiment, the one or more plates may be planar. As shown in FIG. 2, the first plate 119 defines three linear-planar portions 201, 203, 205, connected at two obtuse angles 207, 209. The second plate 121 may also define three linear-planar portions, where adjacent portions are angled with respect to each other at an obtuse angle. In an exemplary embodiment, the one or more plates may be different sizes. As shown in FIGS. 1 and 2, the first plate may be larger than the second plate. Each plate may include a first terminal end toward the head of the toothbrush and a second terminal end toward the handle of the toothbrush, away from the head. The second terminal end of the first plate may overlap with the first terminal end of the second plate, such that the first terminal end of the first plate is closest to the head, the first terminal end of the second plate is closer than the second terminal end of the first plate to the head of the toothbrush, and the second terminal end of the second plate is the furthest away from the head or closest to the handle terminal end. The overlapping sections of the first plate and the second plate may include one of the three linear-planar portions of the respect plates.

As shown in FIG. 1, in an exemplary embodiment, the first plate 119 may be located in substantially the neck 105 and an upper section of the handle 107. The second plate 121 may be located in an upper section of the handle 107, on a second side of the base plate 109. The light source 113, the circuit board 115, and the power source 117 may all be located on a first side of the base plate 109. The light source 113 may be located on the first side of the base plate 109, substantially opposite the portion of the second plate 121 that is located on the second side of the base plate 109. As shown in FIGS. 1 and 2, a lower portion of the first plate 119 may overlap a portion of the second plate 121, with a gap 211 separating the first 119 and second plates 121. The gap 211 may allow the first 119 and second plates 121 to operate as a switch. As such, when the gap 211 decreases and the first 119 and second 121 plates come into contact, the circuit may close, allowing power from the power source to travel to the light source, in turn causing the light source to illuminate.

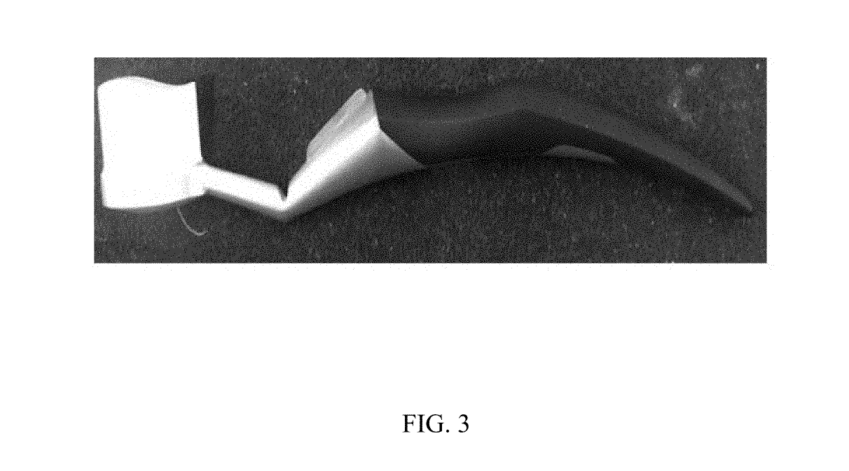

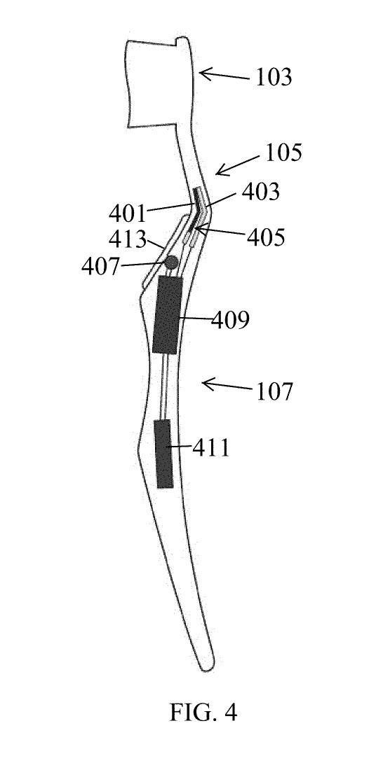

In an exemplary embodiment, the handle may be connected to the neck portion at an angle. The angle may be obtuse, as shown in FIGS. 1 and 4. The angle may be compound as shown in FIG. 3 such that a macro angle is formed between the neck and the handle, and a micro angle is formed along the surface at the macro angle. The macro angle may be obtuse while the macro angle may be acute, as shown in FIG. 3.

In an exemplary embodiment, the neck may be flexible. Therefore, as shown in FIG. 1, the head 103 may move relative to the handle when the toothbrush is in operation, with the neck acting as a pivot arm. The movement of the head 103 may cause a portion of the first plate 119 to move towards the second plate 121, thus reducing the gap between the first 119 and second 121 plates and causing the first 119 and second plates 121 to come into contact. Thus, this movement may cause the circuit to be completed and may therefore cause the light source to emit the light.

In an exemplary embodiment as illustrated in FIG. 4, the one or more plates may comprise a first branch 401 and a second branch 403. The first 401 and second 403 branches may be substantially parallel to one another. The first 401 and second 403 branches may be located substantially close to each other. Additionally, the first 401 and second 403 branches may be separated by a gap 405. The circuit may include the light source 407, the single plate, the circuit board 409, and the power source 411. The circuit may be completed when the first 401 and second 403 branches come into contact. The completion of the circuit may cause power from the power source 411 to travel to the light source 407, thereby causing the light source 411 to emit a light. The light may be amplified by the lens 413.

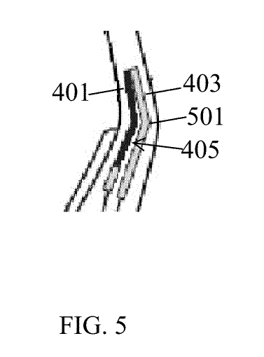

In an exemplary embodiment, the first and second branches may be substantially non-linear. As shown in FIG. 5, the first 401 and second 403 branches may bend at an angle 501. The angle 501 may be located in substantially the point where the neck and the handle meet.

In an exemplary embodiment, the neck may be flexible. Therefore, the head 103 may move relative to the handle 107 when the toothbrush is in operation. As shown in FIG. 4, this movement may cause the gap 405 to decrease and the first 401 and second 403 branches to come into contact. Thus, this movement may cause the circuit to be completed and may therefore cause the light source to emit the light.

In an exemplary embodiment, the circuit may further comprise a timer. The timer may regulate the power to the light source such that the power is supplied to the light source so long as the timer is still running. As such, once the timer has ended, the light source will cease to illuminate until the circuit is once again completed. For example, the timer may begin running when the neck flexes causing the head portion to move relative to the handle, causing the circuit to close and the light source to illuminate. The light source may continue to emit light until the timer stops. In this case, once the timer stops running, the light source will turn off. In an exemplary embodiment, the timer may be set to last approximately the amount of time necessary for an operator to brush his or her teeth. For example, the timer may be set to last approximately 2 minutes.

In an exemplary embodiment, the power source may provide power to the toothbrush. In an exemplary embodiment, the power source may comprise a battery. In an exemplary embodiment, the battery is rechargeable. The power source may also include A/C power, such as through a power cord.

In an exemplary embodiment, the light source may comprise a light emitting diode. In an exemplary embodiment, the light source may emit two colors. The light source may emit a first color when the toothbrush is not in need of replacement and a second color when the toothbrush needs to be replaced.

In an exemplary embodiment, the light source may emit three colors. The light source may emit a first color when the toothbrush is not in need of replacement and a second color when the toothbrush needs to be replaced. Additionally, the light source may emit a third color as a warning that the toothbrush may need to be replaced substantially soon. For example, the toothbrush may emit a first color, such as green, when the toothbrush is substantially new, a second color, such as red, when the toothbrush has neared the end of its life cycle and a third color, such as yellow, when the toothbrush is approximately halfway through its life cycle.

In an exemplary embodiment, the toothbrush may also comprise a counter. The counter may keep track of the number of times the indicator assembly has been activated. In an exemplary embodiment, the counter may alert the light source as to what color the light source should display. For example, the light source may display a certain color for a predetermined number of activations of the indicator assembly. Once that number exceeds the predetermined number of activations, the light source may display another color. In an exemplary embodiment, the light source may display the first color until the counter reaches 240, at which point the light source will display the third color until the counter reaches 480, at which point the light source will display the second color, notifying the user that a replacement toothbrush is necessary.

In an exemplary embodiment, the handle may be ergonomic. The handle may comprise multiple ridges on an outside surface in order to increase friction. The handle may comprise a soft portion in order to provide a more comfortable gripping portion. The handle may comprise a concave section that aids in the holding of the toothbrush.

In an exemplary embodiment, the head may comprise a first side and a second side. The first side may further comprise one or more sets of protrusions. The one or more sets of protrusions may be substantially vertical and may project away from the second side of the head. The one or more sets of protrusions may be bristle-like and/or peg-like. The one or more sets of protrusions may be substantially flexible. The second side may comprise one or more ridges. The one or more ridges may protrude substantially vertically away from the first side of the head. The one or more ridges may be substantially rigid, flexible, or a combination thereof.

In an exemplary embodiment, the toothbrush may be between 180-185 millimeters long. The head may be between 12 and 13 millimeters wide and between 22 and 24 millimeters long. The handle may taper. In an exemplary embodiment, the handle portion may include a widest portion that is 10-25 millimeters, such as 18-23 millimeters, and under 10 millimeters, such as 4-6 millimeters at is narrowest.

The lengths and measurements provided herein are exemplary only. For example, a heated bristle may have a heating component along the entire length of the bristle. The overall size of a brush may be reduced or enlarged such that the dimensions may scale for smaller and larger embodiments. The ranges are provided for simplicity and are meant to include every measurement, at least on a 0.001 increment between and inclusive of the identified endpoints. For example, a range of 0.001 to 0.004 would include each of 0.001, 0.002, 0.003, 0.004, and any combination thereof.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. No single feature is considered essential or necessary to the invention. Instead, the invention includes exemplary features that may be used in one or more combinations are provided herein. The scope of the invention should be determined by the claims only, and not limited by the exemplary embodiments provided herein.

What is claimed is:

1. A toothbrush, comprising:
a head;
a handle;
a neck connecting the head to the handle, and the neck meeting the handle at an angle; and
an indicator assembly configured to activated when the head moves relative to the handle.

2. The toothbrush according to claim 1, wherein the indicator assembly further comprises:
one or more contact plates;
a light source;
a circuit board;
and a power source;
wherein the circuit board connects the power source and the light source, to the one or more contact plates;
wherein the one or more plates act as a switch that activates the indicator assembly; and
wherein power travels from the power source to the light source and the light source emits a light when the indicator assembly is activated.

3. The toothbrush according to claim 2, wherein the toothbrush further comprises a lens that amplifies the light emitted by the light source.

4. The toothbrush according to claim 2, wherein the toothbrush further comprises a timer that is connected to the indicator assembly, such that the timer controls an amount of time the indicator assembly is triggered for.

5. The toothbrush according to claim 4, wherein the one or more plates comprise a first plate and a second plate;
wherein the first plate and second plate are separated by a gap;
wherein the gap closes and the first plate contacts the second contact plate when the head moves relative to the neck; and
wherein the first plate contacting the second plate activates the indicator assembly.

6. The toothbrush according to claim 5, wherein the one or more plates comprise a single plate with a first branch and a second branch;
wherein the first branch and the second branch are separated by a gap;
wherein the gap closes and the first branch contacts the second branch when the head moves relative to the neck; and
wherein the first branch contacting the second branch activates the indicator assembly.

7. The toothbrush according to claim 4, wherein the toothbrush further comprises a counter that tracks an amount of times the indicator assembly has been activated.

8. The toothbrush according to claim 7, wherein the light source emits a plurality of colors;
wherein the color emitted by the light source is dependent on the number tracked by the counter.

9. A toothbrush comprising:
a head;
a neck; and
a handle;
wherein the neck is in between the head and the handle;
wherein the neck and the handle meet at an angle;
wherein the handle comprises an indicator assembly, a timer, and a counter;
wherein the indicator assembly further comprises: one or more contact plates; a light source; a circuit board; and a power source;
wherein the circuit board connects the power source and the light source, to the one or more contact plates;
wherein the light source emits multiple colors of light;
wherein the one or more plates act as a switch that activates the indicator assembly;
wherein the indicator assembly is activated when the head moves relative to the neck; and
wherein power travels from the power source to the light source and the light source emits a light when the indicator assembly is activated;
wherein the timer deactivates the indicator assembly after an amount of time has elapsed;
wherein the counter tracks a number of times the indicator assembly is activated; and
wherein the color of the light emitted by the light source is dependent on the number tracked by the counter.
